(19) United States
(12) Patent Application Publication
(10) Pub. No.: US 2008/0107010 A1
(43) Pub. Date: May 8, 2008

(54) High Density, Hybrid Optical Disc

(75) Inventor: John Matthew Town, Ojai, CA (US)

Correspondence Address: Joseph S. Tripoli, Thomson Licensing Inc., P.O. BOX 5312, PRINCETON, NJ, 08543-5312, US

(73) Assignee: Joseph S. Tripoli, Princeton, NJ (US)

(21) Appl. No.: 11/795,631

(22) PCT Filed: Oct. 31, 2005
(86) PCT No.: PCT/US05/39321

§ 371 Date: Jul. 19, 2007

Related U.S. Application Data
(60) Provisional application No. 60/646,702, filed on Jan. 25, 2005.

(51) Int. Cl. G11B 7/24; G11B 20/12; G11B 7/007

(52) U.S. Cl. 369/283

(57) ABSTRACT

The present invention advantageously provides a high density, hybrid optical disc and method of manufacture, thereof. In one embodiment of the present invention, a high-density, hybrid optical disc includes first and second disc portions adhesively bonded to each other, each of the disc portions containing at least one transparent substrate and a data layer, where at least one of the first and second disc portions comprises a high density format. The data layer of the second disc portion of the hybrid optical disk is coated with a high transmissive/low reflective layer and is situated opposite a transparent assembling adhesive layer joining the first and second disc portions.

### CROSS-REFERENCE TO RELATED APPLICATIONS

This application claims priority to U.S. Provisional Patent Application Ser. No. 60/646,702, filed Jan. 25, 2005, which is herein incorporated by reference in its entirety.

### TECHNICAL FIELD

This invention relates to optical recording discs, and more particularly, to a high density, hybrid optical disc and method of producing the same.

### BACKGROUND ART

Optical discs for recording and reproducing information by irradiating the optical discs with a laser beam exist in various formats such as a read-only type compact disc (CD-DA, CD-ROM), a write-once type compact disc (CD-R), a rewritable type compact disc (CD-RW), etc. Typically, each of the discs is made of a base board having a diameter of 120 mm and a thickness of about 1.2 mm and is designed to be recorded and reproduced by a laser beam of substantially 780 nm.

Further to the compact discs described above, there exist digital versatile discs (DVD). In a DVD, a moving picture can be stored in the disc having the same diameter of 120 mm as that of the compact disc with an image quality similar to that of a present-day television. The DVD needs to increase a storage capacity to six to eight times as high as that of the compact disc. As such, the DVD records and reproduces data by using a laser beam having a wavelength of typically 635 to 650 nm, which is shorter than the laser beam used for the compact disc or the like. While the compact disc is made of a single board, the DVD is formed by bonding base boards of 0.6 mm together. A read-only type DVD includes two types of DVDs. A first one of them is a DVD wherein two base boards having recording surfaces are bonded together and both the surfaces are used as signal recording surfaces. The other of them is a DVD wherein a base board having a signal recording surface is bonded to a dummy base board having no signal recording surface and the single surface is used as a signal recording surface.

Recently another disc called a Blu-ray disc has been introduced having a typical diameter of 120 mm like the compact disc or the DVD. In the Blu-ray disc, a moving picture can be stored with an image quality similar to that of a high definition television. The Blu-ray Disc introduced typically has three types of storage capacity including 23.3 Gbytes, 25 Gbytes and 27 Gbytes. The Blu-ray Disc typically uses a laser beam having a wavelength of approximately 405 nm, far shorter than that of the DVD. Further, the Blu-ray Disc typically has a structure where a recording layer and a reflecting layer are laminated on a disc board having a thickness of 1.1 mm and a transparent cover layer of 0.1 mm on an uppermost layer to ensure a tilt margin.

As described above, a plurality of kinds of optical discs, such as the compact discs, the DVDs, and the Blu-ray Discs are known in the art, however there does not currently exist an optical disc with a combination of these optical disc formats and manufactured in a cost effective manner.

### BRIEF SUMMARY OF THE INVENTION

The present invention addresses the deficiencies of the prior art by providing a high density hybrid optical disc and method of manufacture, thereof.

In one embodiment of the present invention, a hybrid optical disc includes first and second disc portions adhesively bonded to each other, each of the disc portions containing at least one transparent substrate and a data layer, where at least one of the first and second disc portions comprises a high density format. The data layer of the second disc portion of the hybrid optical disk is coated with a high transmissive/low reflective layer and is situated opposite a transparent assembling adhesive layer joining the first and second disc portions.

In an alternate embodiment of the present invention, a method for manufacturing a hybrid optical disc of the present invention includes producing a first disc portion by pressing at least a portion of a first transparent substrate to fashion a first data layer according to a first standard, the data layer being coated with a reflecting layer, producing a second disc portion by pressing at least a portion of a second transparent substrate to fashion a second data layer according to a second standard, the second data layer being coated with a high transmissive/low reflective layer and then protected by a protective layer. The method further includes adhesively bonding the two disc portions to each other such that the second data layer of the second disc portion is opposite the adhesive layer, where at least one of the first and second disc portions comprises a high density format.

In yet an alternate embodiment of the present invention, a dual-format, hybrid optical disc includes a first half-disc having a first format and a second half-disc having a second format, where at least one of the first format and the second format is a high-density format. The first half-disc and the second half-disc are bonded together to make a full-thickness disc such that both formats are read from a common side of the full-thickness disc.

In still an alternate embodiment of the present invention, a method for manufacture of a dual-format, hybrid optical disc of the present invention includes, recording a high-density format on a first side of a first half disc, recording a relatively, lower density format on a first side of a second half disc and bonding the first half disc to the second half disc to provide a dual-format full-thickness hybrid optical disc such that both formats are read from a common side of the full-thickness disc.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a high density, hybrid optical BD/DVD disc in accordance with an embodiment of the present invention;

FIG. 2 depicts a flow diagram of a method for manufacturing a BD/DVD disc in accordance with one embodiment of the present invention;

FIG. 3 depicts a high level block diagram of a high density, hybrid optical BD/CD disc in accordance with an alternate embodiment of the present invention; and

FIG. 4 depicts a flow diagram of a method for manufacturing a BD/CD disc, such as the BD/CD of FIG. 3, in accordance with one embodiment of the present invention.

To facilitate understanding, identical reference numerals have been used, where possible, to designate identical elements that are common to the figures.

### DETAILED DESCRIPTION

The present invention advantageously provides a high density hybrid optical disc and method of manufacture, thereof. Although throughout the teachings herein and in various embodiments of the present invention, the aspects of the present invention are described within the context of a high density, hybrid optical disc comprising various specific format combinations, the specific embodiments of the present invention should not be treated as limiting the scope of the invention. It will be appreciated by those skilled in the relevant art and informed by the teachings of the present invention that the concepts of the present invention may be applied for providing high density, hybrid optical discs comprising at least one high density optical disc portion (half-disc) that may also be combined with substantially any other lower density media portion or portions (half-disc(s)).

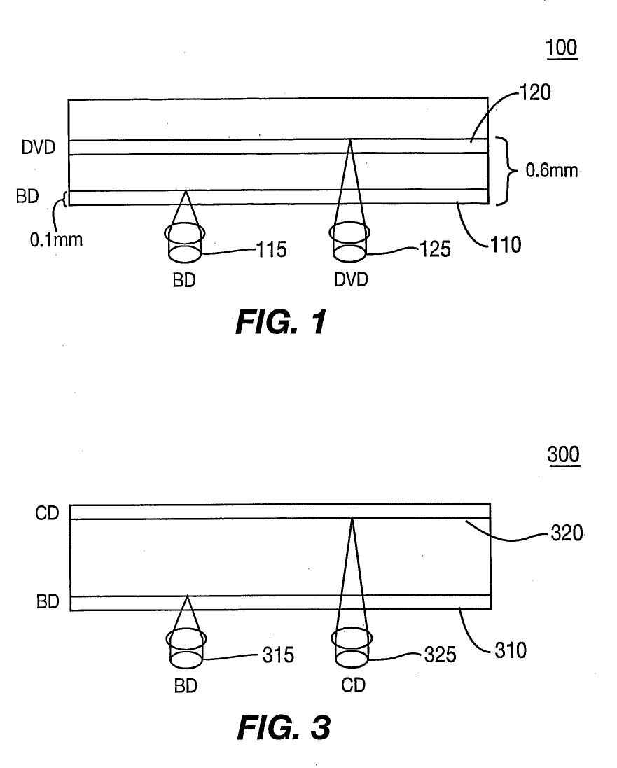

In one embodiment of the present invention, a high density, hybrid optical disc in accordance with the present invention comprises a Blu-ray disc (BD) layer and a DVD layer. For example, FIG. 1 depicts a high level block diagram of a high density, hybrid optical BD/DVD disc 100 in accordance with an embodiment of the present invention. As depicted in FIG. 1, the BD/DVD disc 100 of FIG. 1 comprises an outer BD layer 110 and an inner DVD layer 120. The BD/DVD disc 100 is formed in such a way that the DVD layer 120 on which data is recorded on the basis of the DVD standard is bonded to the BD layer 110 on which data is recorded on the basis of the Blu-ray Disc standard using a transparent adhesive layer. The high density, hybrid optical BD/DVD disc 100 comprises a disc that would play in either a DVD player (e.g., 650 nm; NA=0.6) and/or a Blu-ray player (e.g., 405 nm; NA=0.85.). FIG. 1 further depicts a BD laser 115 and a DVD laser 125 for reading the BD data and the DVD data, respectively.

More specifically, in one embodiment the present invention uses DVD half-disc bonding technology (e.g., transparent assembling adhesive layer) to make one dual-format full-thickness disc with both formats read from, in the embodiment of FIG. 1, the same side. The DVD single-layer recording is performed on an A-Side at reverse rotation similar to a Layer-1 Parallel Track Path recording for dual-layer. The DVD single-layer recording is made on the physical surface of the disc analogous to Layer-1 rather than Layer-0 technology. A B-side of the original molded replica is made using a non-standard 0.5 mm mold cavity. The B-side stamper is high density (e.g. Blu-ray). The B-side disc is sputtered with a high transmissive/low reflectivity coating suitable for 405 nm laser (e.g. silver or silicon hydride). The B-side disc is turned over to have the sputtered data surface on the outside of the disc during bonding. The bonded disc with the B-side data surface on top is spin-coated utilizing, in one embodiment of the present invention, UV-cure lacquers to build up a 0.1 mm cover layer. The finished disc receives a label print on the A-side disc surface unlike all other DVD discs. That is, the final high density, hybrid optical BD/DVD disc 100 is printed with a label over the entire surface of the A-side disc. The DVD layer (e.g., 650 nm; NA=0.6) is read through the B-side of the disc with the red laser reading through the 0.1 mm spin-coated cover-layer and through the high-density data surface to the reach the DVD data layer molded on the A-side disc. That is, the BD layer is transparent for the red laser light implemented for the DVD portion. As depicted in FIG. 1, the DVD data layer is approximately 0.6 mm from the outer most surface (e.g., the BD cover layer) of the B-side. Because in the embodiment of FIG. 1 the BD cover layer is 0.1 mm, the BD layer and the DVD layer in the embodiment of the invention depicted in FIG. 1 are separated by a transparent layer of approximately 0.5 mm.

The finally bonded high density BD/DVD disc 100 is configured such that the reflecting layer of the DVD disc portion is located adjacent to the location of the bond (e.g., adhesive layer) as depicted in FIG. 1.

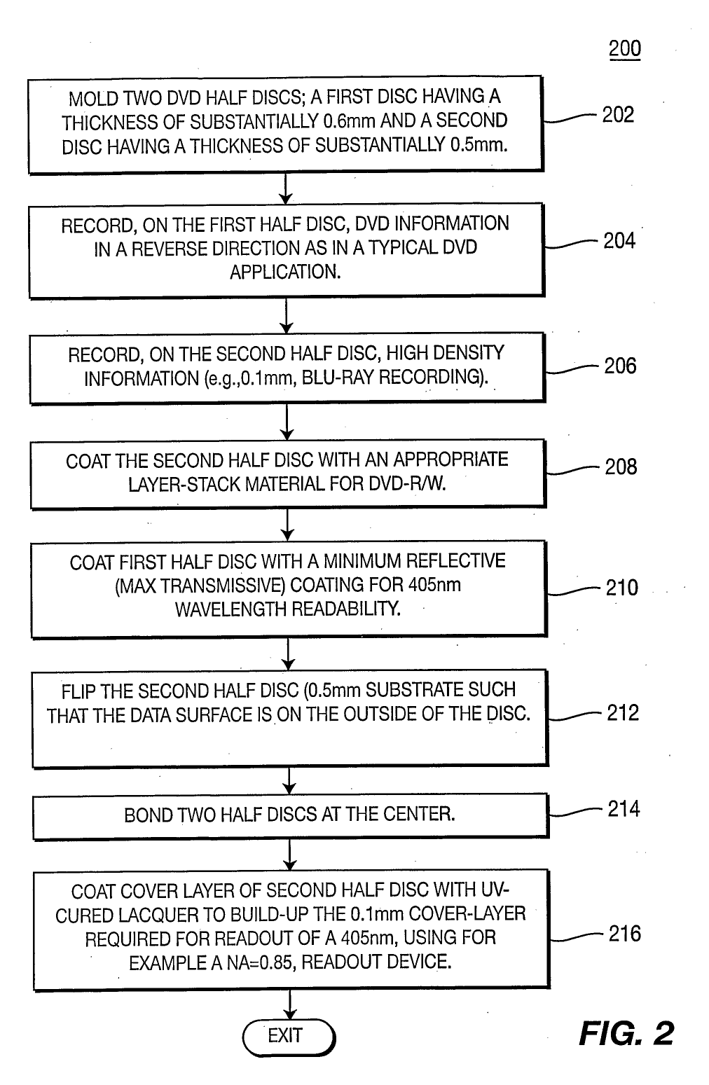

FIG. 2 depicts a flow diagram of a method for manufacturing a BD/DVD disc, such as the BD/DVD 100 of FIG. 1, in accordance with one embodiment of the present invention. The method 200 of FIG. 2 is entered at step 202 by molding two DVD half discs (elementary discs) using DVD half disc molding technology known in the art, the DVDs comprising a first disc having a thickness of substantially 0.6 mm and a second disc having a thickness of substantially 0.5 mm. The method 200 then proceeds to step 204.

At step 204, on the first half disc a stamper is recorded (e.g., pressed) with DVD information in a reverse direction of a typical DVD application (e.g., reverse direction as DVD5) because the DVD information will be read through the second half disc. The method 200 then proceeds to step 206.

At step 206, the second half disc is recorded (e.g., pressed) as a standard high density (e.g., 0.1 mm) recording (eg., Blu-ray). The method 200 then proceeds to step 208.

At step 208, the first half disc is coated with an appropriate layer-stack material for DVD-R/W such as a silver or aluminum full reflective layer applied for example in a sputtering machine. The method 200 then proceeds to step 210.

At step 210, the second half disc is coated with a minimum reflective (max transmissive) coating for 405 nm wavelength readability. The method 200 then proceeds to step 212.

At step 212 and prior to bonding the first half disc and the second half disc, the second half disc (0.5 mm substrate) is positioned (flipped) such that the data surface is on the outside of the combined disc. That is, the first half disc and the second half disc are positioned relative to each other such that the data surface of the second half disc remains on the outside (reading side) of the discs when combined and the data surface of the first half disc remains between the discs when combined. The method 200 then proceeds to step 214.

At step 214, the two half discs are joined at the center using a means of DVD UV bonding known in the art (e.g., a transparent assembling adhesive layer). The method 200 then proceeds to step 216.

At step 216, the Blu-ray cover layer is coated with UV-cured lacquer to build-up the 0.1 mm cover-layer required for readout of a 405 nm, using for example a NA=0.85, readout device. The method 200 is then exited.

FIG. 3 depicts a high level block diagram of a high density, hybrid optical BD/CD disc 300 in accordance with an alternate embodiment of the present invention. As depicted in FIG. 3, the BD/CVD disc 300 of FIG. 1 comprises a BD layer 310 and a CD layer 320. The BD/CD disc 300 is formed in such a way that the CD layer 320 on which data is recorded on the basis of the CD standard is bonded to the BD layer 310 on which data is recorded on the basis of the Blu-ray Disc standard through an adhesive layer. The high density, hybrid optical BD/CD disc 300 comprises a disc that would play in either a CD (e.g., -R/W) player (e.g., 780 nm; NA=0.6) and/or a Blu-ray player (e.g., 405 nm; NA=0.85.). FIG. 3 further depicts a BD laser 315 and a CD laser 325 for reading the BD data and the CD data, respectively.

More specifically, the BD/CD disc 300 of FIG. 3 uses CD/DVD half-disc bonding technology (e.g., transparent assembling adhesive layer) to make one dual-format full-thickness disc with both formats read from, in the embodiment of FIG. 3, the same side. An A-Side of a first half-disc comprises a stamper that is recorded as a regular CD (e.g., -R/W) and is made up on a half-thickness 0.6 mm disc. A B-side of the original molded replica is made using a non-standard 0.5 mm mold cavity. The B-side stamper is high density (e.g. Blu-ray). The B-side disc is sputtered with a high transmissive/low reflectivity coating suitable for 405 nm laser (e.g. silver or silicon hydride). The B-side disc is turned over to have the sputtered data surface on the outside of the disc during bonding. The bonded disc with the B-side data surface on top is spin-coated utilizing UV-cure lacquers to build up a 0.1 mm cover layer. The A-side half-disc having the CD data is also turned over so that the CD data surface is on the outside of the disc and is the bottom surface of the disc during bonding. The two half-discs having the A-side and B-side are then bonded using a DVD bonder. The bonded surfaces are the clear (non-data) surfaces of the A- and B-side substrates.

The bonded disc is printed with a label over the entire surface of the A-side disc. The CD (e.g., -R/W) layer (e.g., 780 nm; NA=0.45) is read through the B-side of the disc with the infra-red laser reading through the 0.1 mm spin-coated cover-layer and through the high-density data surface to reach the CD data layer molded on the A-side disc. That is, the BD layer is transparent for the infra-red laser light implemented for the CD portion. As described above, the CD portion of the disc is made up on a half-thickness 0.6 mm disc and the B-side (e.g., Blu-ray portion of the disc) is made using a non-standard 0.5 mm mold cavity. As such, in the embodiment of the present invention depicted in FIG. 3, the BD layer and the CD layer are separated by a transparent spacer layer of approximately 1.1 mm.

The finally bonded high density BD/CD disc 300 is configured such that the reflecting layer of the CD disc portion is located opposite to the location of the bond (e.g., adhesive layer) as depicted in FIG. 3.

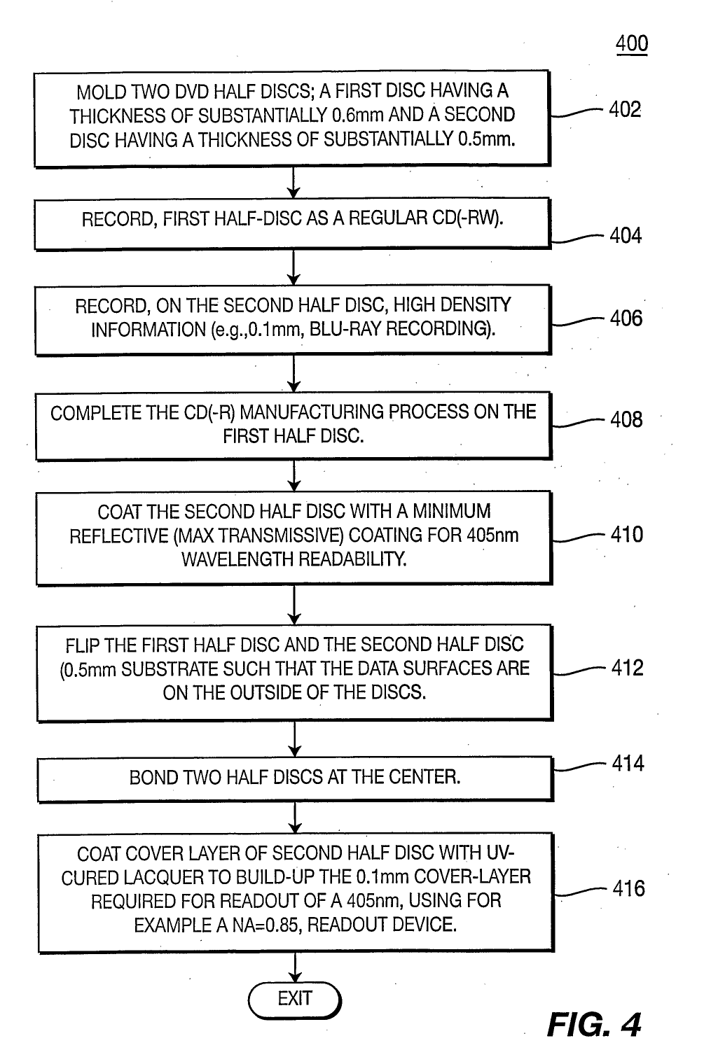

FIG. 4 depicts a flow diagram of a method for manufacturing a BD/CD disc, such as the BD/CD 300 of FIG. 3, in accordance with one embodiment of the present invention. The method 400 of FIG. 4 is entered at step 402 by molding two CD (DVD) half discs using CD/DVD half disc molding technology known in the art, the CDs comprising a first disc having a thickness of substantially 0.6 mm and a second disc having a thickness of substantially 0.5 mm. The method 400 then proceeds to step 404.

At step 404, on the first half disc a stamper is recorded (e.g., pressed) as a regular CD (e.g., -R/W). The method 400 then proceeds to step 406.

At step 406, the second half disc is recorded (e.g., pressed) as a standard 0.1 mm recording (eg., Blu-ray). The method 200 then proceeds to step 408.

At step 408, the CD (e.g., -R) manufacturing process is completed on the first half disc. The method 200 then proceeds to step 410.

At step 410, the second half disc is coated with a minimum reflective (max transmissive) coating for 405 nm wavelength readability. The method 400 then proceeds to step 412.

At step 412 and prior to bonding the first half disc and the second half disc, the first half disc (0.6 mm substrate) and the second half disc (0.5 mm substrate) are positioned (flipped) relative to each other such that the data surfaces of the respective discs are on the outside of the discs as opposed. The method 400 then proceeds to step 414.

At step 414, the two half discs are joined at the center using a means of DVD UV bonding known in the art. The method 400 then proceeds to step 416.

At step 416, the Blu-ray 0.1 mm cover layer is coated with UV-cured lacquer to build-up the 0.1 mm cover-layer required for readout of a 405 nm using for example a NA=0.85 readout device. The method 400 is then exited.

Having described various embodiments of high-density, hybrid optical discs and methods of manufacture of such discs (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. That is, while the forgoing is directed to various embodiments of the present invention, other and further embodiments of the invention may be devised without departing from the basic scope thereof. As such, the appropriate scope of the invention is to be determined according to the claims, which follow.

1. Optical disc, comprising:
first and second disc portions adhesively bonded to each other, each of the disc portions containing at least one transparent substrate and a data layer, the data layer of the second disc portion being coated with a high transmissive/low reflective layer and being situated opposite a transparent assembling adhesive layer joining said first and second disc portions, wherein at least one of said first and second disc portions comprises a high density format.

2. Optical disc according to claim 1, wherein the data layer of the first disc portion is coated with a reflecting layer and is located adjacent to said transparent assembling adhesive layer.

3. Optical disc according to claim 2, wherein the data layer of the first disc portion is produced according to a DVD standard and the data layer of the second disc portion is produced according to a Blu-ray disc (BD) standard, and in that the first and second disc portions each have a thickness of approximately 0.6 mm.

4. Optical disc according to claim 3, wherein DVD data and BD data are read from a common side of said optical disc.

5. Optical disc according to claim 3, wherein the data layer of the first disc portion and the data layer of the second disc portion are separated by a transparent layer of approximately 0.5 mm.

6. Optical disc according to claim 1, wherein the data layer of the first disc portion is coated with a reflecting layer and is located opposite to said transparent assembling adhesive layer.

7. Optical disc according to claim 6, wherein the data layer of the first disc portion is produced according to a CD standard and the data layer of the second disc portion is produced according to a Blu-ray disc (BD) standard, and in that the first and second disc portions each have a thickness of approximately 0.6 mm.

8. Optical disc according to claim 7, wherein CD data and BD data are read from a common side of said optical disc.

9. Optical disc according to claim 7, wherein the data portion of the first elementary disc and the data portion of the second elementary disc are separated by a transparent layer of approximately 1.1 mm.

10. Optical disc according to claim 1, wherein the data layers of the first and second disc portions are produced according to two mutually different standards.

11. Optical disc according to claim 1, wherein the high transmissive/low reflective layer has a thickness of approximately 0.1 mm.

12. Optical disc according to claim 1, wherein the high transmissive/low reflective layer is spin-coated.

13. Optical disc according to claim 1, wherein the high transmissive/low reflective layer is spin-coated utilizing UV-cure lacquers.

14. Method for manufacturing an optical disc, comprising the steps of:
producing a first disc portion by pressing at least a portion of a first transparent substrate to fashion a first data layer according to a first standard, the data layer being coated with a reflecting layer;
producing a second disc portion by pressing at least a portion of a second transparent substrate to fashion a second data layer according to a second standard, the second data layer being coated with a high transmissive/low reflective layer and then protected by a protective layer; and
adhesively bonding the two disc portions to each other such that the second data layer of the second disc portion is opposite the adhesive layer;
wherein at least one of said first and second disc portions comprises a high density format.

15. Method according to claim 14, wherein the first and the second disc portions are bonded such that the reflecting layer of the first disc portion is adjacent to said adhesive layer.

16. Method according to claim 15, wherein the data layer of the first disc portion is produced according to a DVD standard and the data layer of the second disc portion is produced according to a Blu-ray disc (BD) standard, and in that the first and second disc portions each have a thickness of approximately 0.6 mm.

17. Method according to claim 16, wherein DVD information is recorded in a reverse direction of a typical DVD application during said producing.

18. Method according to claim 14, wherein the first and the second disc portions are bonded such that the reflecting layer of the first disc portion is opposite said adhesive layer.

19. Method according to claim 18, wherein the data layer of the first disc portion is produced according to a CD standard and the data layer of the second disc portion is produced according to a Blu-ray disc (BD) standard, and in that the first and second disc portions each have a thickness of approximately 0.6 mm.

20. Method according to claim 14, wherein the high transmissive/low reflective layer of the second disc portion comprises a minimum reflective, maximum transmissive coating for 405 nm wavelength readability.

21. A high-density, hybrid optical disc having dual formats, comprising:
a first half-disc having a high density format; and
a second half-disc having a relatively, lower density format;
wherein the first half-disc and the second half-disc are bonded together to make a dual-format full-thickness optical disc such that both formats can be read from a common side of the full-thickness optical disc.

22. A method for manufacture of a high-density, hybrid optical disc having dual formats, comprising:
recording a high density format on a first side of a first half disc;
recording a relatively, lower density format on a first side of a second half disc; and
bonding the first half disc to the second half disc to provide a dual-format full-thickness hybrid optical disc such that both formats can be read from a common side of the full-thickness optical disc.

23. The method of manufacture of claim 20, wherein said high density format comprises a blu-ray disc (BD) high density format.
